(19) United States
(12) Patent Application Publication
(10) Pub. No.: US 2003/0147573 A1
(43) Pub. Date: Aug. 7, 2003

(54) Roller bearing

(76) Inventors: Arnold Bokel, Schwebheim (DE); Hans-Jurgen Liesegang, Schortens (DE)

Correspondence Address: BURNS, DOANE, SWECKER & MATHIS, L.L.P., P.O. Box 1404, Alexandria, VA, 22313-1404, US

(21) Appl. No.: 10/338,649

(22) Filed: Jan. 9, 2003

(30) Foreign Application Priority Data
Jan. 9, 2002 (DE) 202 00 241.1

(51) Int. Cl. F16C 33/32; F16C 33/62

(52) U.S. Cl. 384/492

(57) ABSTRACT

A roller bearing includes an inner bearing ring, an outer bearing ring, and roller bodies arranged between the inner bearing ring and the outer bearing ring, with at least one of the inner and outer bearing rings, preferably both, being at least partially comprised of fiber composite material or plastic material. A plurality of driving pins are arranged on one of the bearing rings and are evenly distributed circumferentially on the one bearing ring for engagement with a driving pinion to drive the bearing ring.

This application is based on and claims priority under 35 U.S.C. §119 with respect to German Application No. 202 00 241.1 filed on Jan. 9, 2002, the entire content of which is incorporated herein by reference.

### FIELD OF THE INVENTION

This invention generally relates to bearings. More particularly, the present invention pertains to a roller bearing having an inner ring, an outer ring and roller bodies arranged between the inner and outer rings.

### BACKGROUND OF THE INVENTION

It is known from U.S. Pat. No. 5,866,647 to use a fiber composite as the base material for producing the rings of a roller bearing, with the strength of the material being increased by fiber glass or similar fiber materials. Compared to steel, such materials are characterized by relatively low weight, relatively high corrosion resistance and generally low thermal expansion.

Particularly with large roller bearings of the generic type which are, for instance, embodied either as a turnstile bearing or as a hinge bearing, it is occasionally required to directly drive one of the bearing rings via a gear mechanism. For this purpose, one of the bearings rings is equipped with external toothing which engages a drive pinion to thus drive the bearing ring. This type of arrangement is typically not a problem with chassis rings made of metal. However, if these rings are made of plastic or fiber composite materials, the strength of the material generally is not sufficient to transmit the drive forces. In this case, a sprocket made of metal must be attached to the respective bearing ring.

This has the negative effect of substantially increasing the weight of the bearing. Also, an additional metal component is necessary, namely the sprocket. Further, problems may result due to the varying thermal expansions of the metal material on the one hand and the plastic or fiber composite material on the other hand. In this case, the connection of the sprocket with the ring may not be completely free of problems or difficulties.

It would thus be desirable to provide a bearing of the general type described above that is constructed so that significant or full advantages can be taken of the fiber composites or plastic as the material for the bearing rings without having to contend to a significant extent with disadvantages such as those mentioned above in order to drive one of the bearing rings.

### SUMMARY OF THE INVENTION

A roller bearing includes at least one of the bearing rings, preferably both bearing rings, being made at least partially of fiber composite or plastic material, with a number of driving pins arranged on one of the bearing rings in a manner evenly distributed across its circumference.

With this arrangement, it is possible to use a so-called driving pinwheel for driving one of the bearing rings. The bearing ring to be driven is equipped with the driving pins that are suitable for engaging into a tooth (between teeth) of the drive pinion, whereby the drive of the bearing ring can be performed by the drive pinion.

Advantageously, the axis of the driving pins extends in the direction of the bearing axis. Also, metallic wires, especially steel wires, are preferably arranged both on the inner ring and on the outer ring for the startup of the roller bodies.

The inner ring or the outer ring can be configured to have a U-shaped cross-section, with the driving pins fully engage both of the shanks forming the U-shaped cross-section. As an alternative, the inner ring or the outer ring can possess a ring-shaped cross-section, with the driving pins protruding over the ring-shaped section on one side. According to another alternative, the inner ring or the outer ring can have a ring-shaped cross-section, with the driving pins protruding over the ring-shaped section on both sides.

The fiber composite utilized as the material for the bearing rings can contain carbon fiber. As an alternative, or in addition, fiberglass may also be used. The driving pins arranged on one of the bearing rings are preferably made of a metal, with steel being a preferred material.

The roller bearing is advantageously embodied either as a turnstile bearing or as a hinge bearing.

The inner ring and/or the outer ring of the bearing can be equipped with threaded bores, across which assembly parts of the roller bearing are attached to the rings. It is also possible to embody at least one of the bearing rings so that the bearing ring is comprised of plural ring segments rather than one single piece. Also, a functional element can be integrated in the bearing rings consisting of fiber composite or plastic. This functional element can consist of either an electric winding, or additional toothing.

The roller bearing construction makes it possible to realize a relatively large-scale bearing having a relatively low weight. In addition, the tooth contact of the one toothing that drives the ring still can still have relatively high strength. There are also no significant connection problems between the ring and the driving pin wheels (driving pins) used. Any variation that may exist between the thermal expansion of the material forming the bearing rings (fiber composite, plastic) and the material forming the driving pins (metal) plays no significant role. Further, it is possible to produce the roller bearing at relatively low cost.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 is a radial cross-sectional view of a roller bearing, with the inner ring being provided with driving pin toothing.

FIG. 2 is a radial cross-sectional view of a roller bearing according to an alternative embodiment.

FIG. 3 is a radial cross-sectional view of a roller bearing according to an alternative embodiment.

FIG. 4 is a radial cross-sectional view of a roller bearing according to an alternative embodiment.

FIG. 5 is a radial cross-sectional view of a roller bearing according to an alternative embodiment.

### DETAILED DESCRIPTION

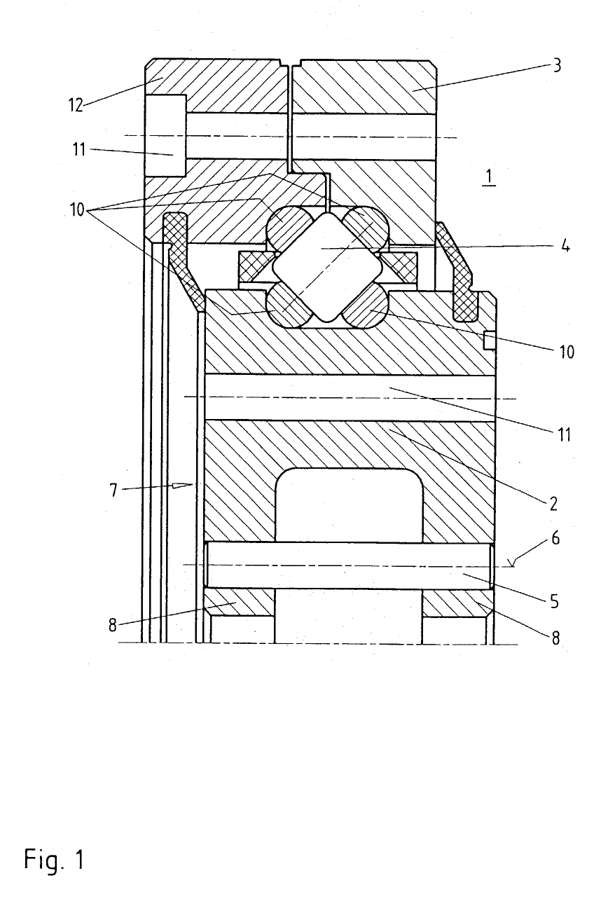

Referring initially to the roller bearing shown in FIG. 1, this illustrated embodiment of the roller bearing 1 includes an inner ring 2, an outer ring 3, and a plurality of roller bodies 4 arranged between the inner ring 2 and the outer ring 3.

The raceway for the roller bodies 4 is formed by metal wires or running wires 10 connected to the inner bearing ring 2 or the outer bearing ring 3, respectively. As illustrated, for example, FIG. 1, the wires 10 are positioned in respective grooves within the inner ring 2 and the outer ring 3. The wires are ground according to the shape of the roller bodies 4 to form the necessary raceway. In the illustrated embodiments, both the inner ring and the outer ring are provided with the wires 10, although it is also possible to provide only one of the bearing rings with the wires while the other bearing ring is formed in a known manner so that it possesses a groove formed according to the shape of the raceway for the roller body. A metal material that has been found to be preferable for fabricating the wires 10 is steel.

At least one of the inner bearing ring 2 and the outer bearing ring 3 is formed at least partially of a base material that is a fiber composite material or a plastic material. Preferably, both the inner bearing ring and the outer bearing ring are made at least partially of fiber composite material or plastic material. In the case of the base material being a fiber composite material, the fiber composite material can include carbon fibers and/or fiberglass. These fibers significantly increase the material strength, yet the density of the material is reduced as compared to pure metal. Details in this regard are described in U.S. Pat. No. 5,866,647.

One of the bearing rings 2, 3 is adapted to be driven by a pinion. In the illustrated embodiment, the inner ring 2 is driven by a pinion. The pinion is adapted to engage or mesh with driving pins 5 arranged at an even circumferential distribution across the circumference of the inner ring. By way of example, the drive pinion can be in the form of a gear-like element having an outer periphery provided with a series of spaced apart teeth, with valleys in between adjacent teeth so that the drive pinion resembles a sprocket. The valleys between the teeth would be adapted to engage the driving pins 5 on the bearing ring to thereby rotate the bearing ring.

The driving pins 5 are preferably made of metal, with steel being a preferred material. As illustrated in FIG. 1, the axis 6 of each of the driving pins 5 is positioned or oriented in the direction of the bearing (i.e., in a direction parallel to the axis of the bearing).

Viewed in cross-section as illustrated in FIG. 1, the inner ring 2 has a U-shaped cross-section 7 possessing two legs or shanks 8. The driving pins or driving pinwheels 5 fully engage into both shanks 8 of the U-shaped section 7 of the inner ring 2.

As also shown in FIG. 1, assembly components 12 for the roller bearing can be attached by screwing-in such components. Threaded bores 11 can be provided for this purpose.

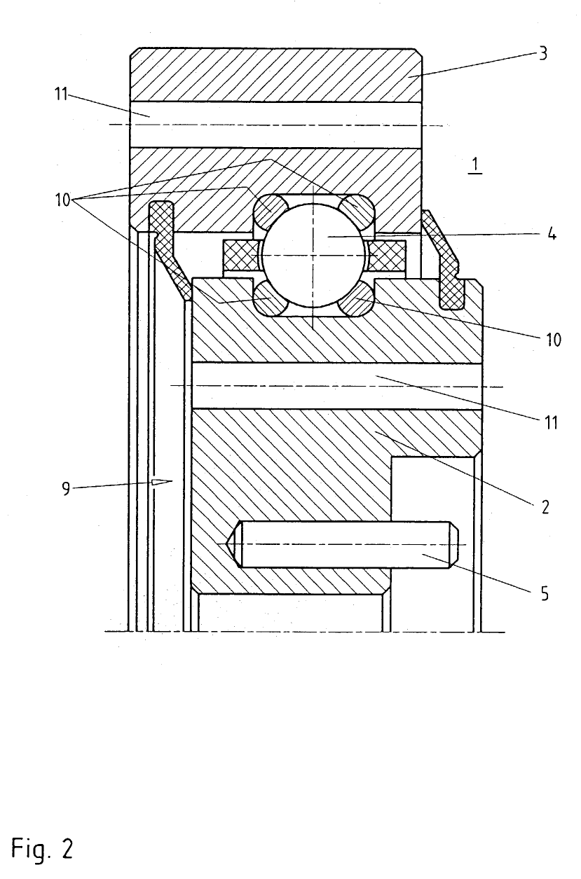

In an alternative embodiment illustrated in FIG. 2, the inner ring 2 is in the form of a ring-shaped section 9. In the illustrated version, the ring-shaped section 9 has an axially extending recess on one axial side. In this embodiment, the driving pins 5 are inserted or positioned so that they protrude from one side of the ring-shaped section 9 in the axial direction. The non-illustrated drive pinion for driving the inner ring 2 is arranged at this axial position.

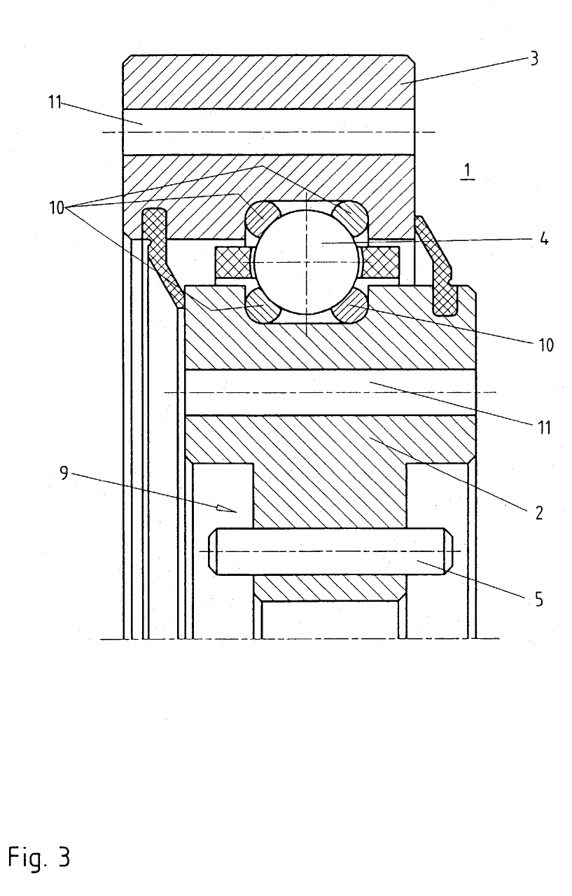

FIG. 3 illustrates an embodiment of the roller bearing in which the driving pins 5 are inserted into or positioned in a ring-shaped section 9 of the inner ring 2 in such a way that the pins 5 protrude from both axial sides of the ring-shaped section 9. This creates the possibility of driving the driving pins 5 by way of two drive pinions. In the illustrated version of the embodiment shown in FIG. 3, axial recesses are provided on both axial sides of the ring-shaped section 9.

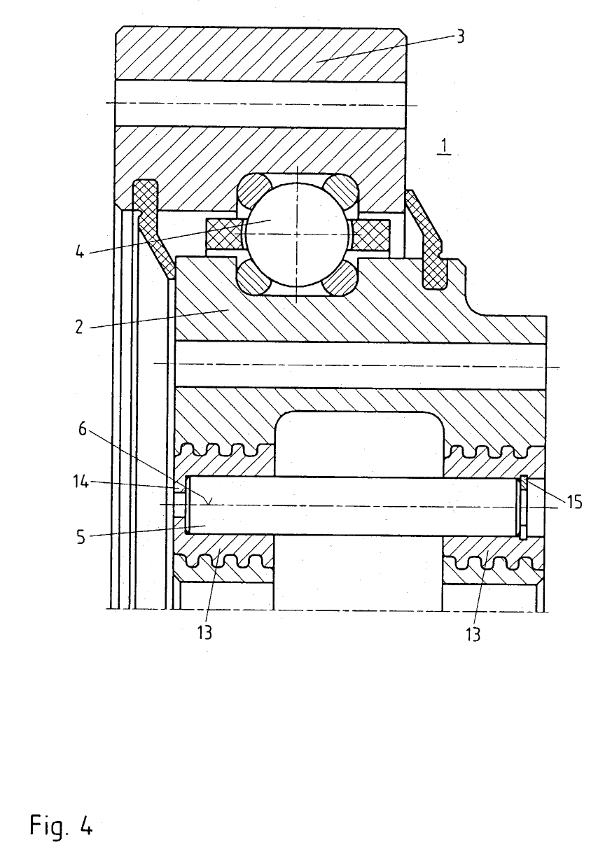

FIG. 4 shows another alternative embodiment in which the driving pins 5 or driving pinwheels are adapted to be exchanged. A guide bushing 13 is arranged in the inner ring 2 and consists of cast-in material, in this illustration, that is hardened at the contact surface with the driving pin 5, and is otherwise protected from corrosion. For this purpose, for instance, the bushing can be nitrocarbureted and oxidized afterward. The individual driving pins 5 are located in a receiving bore of a respective guide bushing 13 with a snug fit. In the embodiment shown in FIG. 4, the inner ring 2 has a U-shaped cross-section, with each leg or shank of the U-shaped cross-section being provided with one of the bushings 13. A stop unit 14 is arranged on one of the two guide bushings 13 to prevent the driving pin 5 from sliding out in one direction (i.e., toward the left in the illustrated arrangement). The axial fixation of the driving pin 5 to prevent the driving pin 5 from sliding out in the other axial direction (i.e., toward the right in the illustrated arrangement) is accomplished by a lock ring 15.

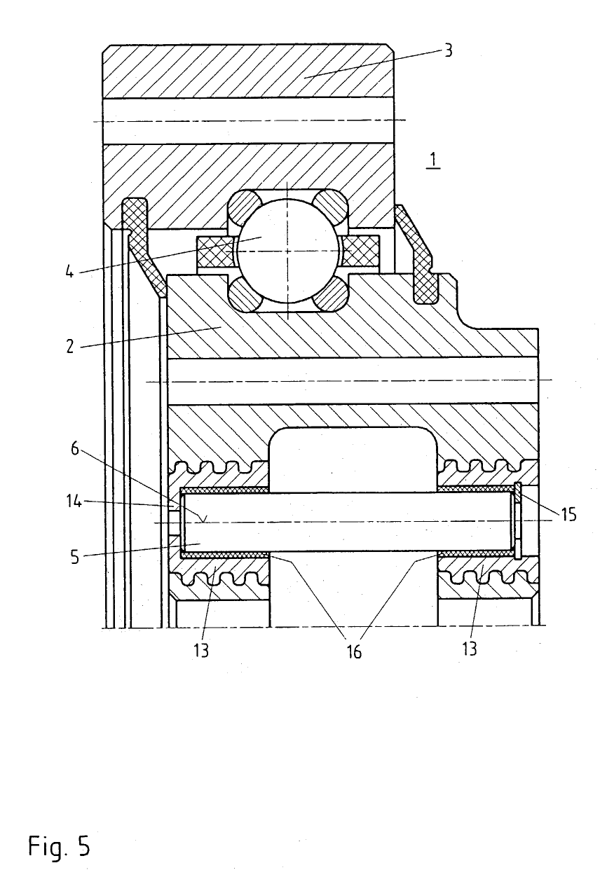

The embodiment shown in FIG. 5 involves the individual driving pins 5 in the guide bushings 13 being supported in a plain bearing coating 16. A tight clearance fit exists between the driving pin 5 and the plain bearing coating 16 in this case. It is possible that the individual driving pins 5 can be contorted by the engagement with a pinion, and so with this embodiment an increase of the stableness of the entire assembly can be achieved because the entire circumference of the driving pins 5 is engaged in contact with the plain bearing coating 16.

It is also possible, although not illustrated in the drawing figures, to equip the driving pins 5 with a hexagon at their ends so that they can be specifically arranged in four different assembly positions. This can also aid in prolonging the service life of the driving pinwheel.

One or both of the bearing rings 2, 3 can be formed from several ring segments as opposed to forming the bearing ring(s) as a one piece bearing ring. Thus, for example, one or both of the inner and outer bearing rings can be formed of four segments each extending over a circumferential extent of 90°. Such a construction might be useful in the case of, for example, relatively large bearings.

It is also to be understood that one or more functional elements can also be integrated into the bearing rings. The functional element(s) can be in the form of an electric winding or can be in the form of toothing.

The principles, preferred embodiments and modes of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What we claim is:

1. A roller bearing comprising:
an inner bearing ring;
an outer bearing ring;
roller bodies arranged between the inner bearing ring and the outer bearing ring;
at least one of the inner and outer bearing rings being at least partially comprised of fiber composite material or plastic material; and
a plurality of driving pins arranged on one of the bearing rings and evenly distributed circumferentially on the one bearing ring.

2. The roller bearing according to claim 1, wherein the roller bearing possesses an axis and the driving pins each possess an axis extending parallel to the axis of the roller bearing.

3. The roller bearing according to claim 1, wherein the bearing ring in which the driving pins are arranged has a U-shaped cross-section possessing shanks, each driving pin being positioned in both shanks of the U-shaped cross-section.

4. The roller bearing according to claim 1, wherein the bearing ring in which the driving pins are arranged has a ring-shaped section, the driving pins protruding toward one side of the ring-shaped section.

5. The roller bearing according to claim 1, wherein the bearing ring in which the driving pins are arranged has a ring-shaped section, the driving pins protruding toward both sides of the ring-shaped section.

6. The roller bearing according to claim 1, including metallic wires arranged on both the inner ring and the outer ring for startup of the roller bodies.

7. The roller bearing according to claim 1, wherein the at least one of the inner and outer bearing rings is at least partially comprised of fiber composite material that includes carbon fibers.

8. The roller bearing according to claim 1, wherein the at least one of the inner and outer bearing rings is at least partially comprised of fiber composite material that includes fiberglass.

9. The roller bearing according to claim 1, wherein the roller bearing is a turnstile bearing.

10. The roller bearing according to claim 1, wherein the roller bearing is a hinge bearing.

11. The roller bearing according to claim 1, wherein at least one of the inner and outer bearing rings is provided with threaded bores for attaching assembly components.

12. The roller bearing according to claim 1, wherein the driving pins are made of metal.

13. The roller bearing according to claim 1, wherein the driving pins are arranged in respective guide bushings positioned in one of the inner and outer bearing rings.

14. The roller bearing according to claim 13, wherein at least one of the guide bushings has a stop unit to inhibit the driving pin from axially sliding out of the guide bushing.

15. The roller bearing according to claim 13, wherein at least one of the guide bushings has a groove in which is positioned a lock ring to effect axial fixation of the driving pin.

16. The roller bearing according to claim 13, including a plain bearing coating arranged between the driving pin and the respective guide bushing.

17. A roller bearing comprising:
a first bearing ring;
a second bearing ring;
roller bodies arranged between the first bearing ring and the second bearing ring;
the first bearing ring being at least partially formed of fiber composite material or plastic material; and
the first bearing ring being provided with a plurality of circumferentially arranged pins each positioned at the first bearing ring so that a portion of each of the pins is engageable for driving the first bearing.

18. The roller bearing according to claim 17, wherein the roller bearing possesses an axis and the pins each possess an axis extending parallel to the axis of the roller bearing.

19. The roller bearing according to claim 17, wherein the first bearing ring has a U-shaped cross-section possessing shanks, each pin being positioned in both shanks of the U-shaped cross-section, with the portion of each pin that is engageable for driving the first bearing ring being located between the shanks.

20. The roller bearing according to claim 17, wherein the first bearing ring in which the pins are arranged has a ring-shaped section, the portion of each pin that is engageable for driving the first bearing ring being an end portion of the pin that protrudes beyond one side of the ring-shaped section.

21. The roller bearing according to claim 17, wherein one of the first and second bearing rings is an inner bearing ring and the other of the first and second bearing rings being an outer bearing ring.
